(19) United States
(12) Patent Application Publication
(10) Pub. No.: US 2026/0134425 A1
(43) Pub. Date: May 14, 2026

(54) DIRECT CHANNEL APPLICATION TO PAYMENT NETWORK

(71) Applicant: MASTERCARD INTERNATIONAL INCORPORATED, Purchase, NY (US)

(72) Inventor: Ashwin SOUNDARARAJAN, Troy, MI (US)

(21) Appl. No.: 18/943,170

(22) Filed: Nov. 11, 2024

(51) Int. Cl. G06Q 20/40; G06Q 20/22

(52) U.S. Cl. CPC G06Q 20/40; G06Q 20/227

(57) ABSTRACT

Systems and methods for a direct channel application to a payment network can include hosting, at an application server on a payment network, an application enabling a user to communicate information to the payment network; receiving, at the payment network, a payment request for a transaction; determining that the transaction includes payment details associated with the user; accessing a user profile associated with the user; determining, at the payment network, that an issuer is unavailable; in response to determining that the issuer is unavailable, sending the authorization request to a stand-in system on the payment network; determining, at the stand-in system on the payment network, to approve the transaction based in part on transaction history of the user and the user profile including the details of the user received from an instance of the application; and completing, by the payment network, authorization of the transaction.

### BACKGROUND

Conventionally, during a payment card transaction, the issuer of the payment card is responsible for authorizing the transaction (e.g., approve or deny a transaction). Issuers rely on a variety of information, including user data, account information, and transaction history to inform the authorization decision for each transaction. Access to this information helps the issuer make informed, particularized decisions to authorize a given transaction.

In some cases where activities on the payment network benefit from certain information available to the issuer, the issuer may provide this information to systems on the payment network. However, there are several scenarios where the issuer may be unavailable to authorize a transaction (e.g., due to connectivity issues) or may not be set up to provide the user-specific information to the payment network.

### BRIEF SUMMARY

Systems and methods for a direct channel application to a payment network to enable users to directly communicate with a payment network are described. Advantageously, as described herein, an application server at a payment network enables a direct channel for users to interact directly with the payment network. By creating a direct channel between the payment network and the user, the payment network can, among other actions, enhance the accuracy of their transaction authorization, decreasing the rate of fraudulent transactions.

In some aspects, the techniques described herein relate to a method, including: hosting, at an application server on a payment network, an application; receiving, at the application server on the payment network, details of a user from an instance of the application; generating, on the payment network, a user profile associated with the user, wherein the user profile includes the details of the user received from the instance of the application; storing, at a storage resource on the payment network, the user profile associated with the user; receiving, at the payment network, a payment request for a transaction; determining that the transaction includes payment details associated with the user; accessing the user profile associated with the user; sending an authorization request to an issuer to approve or deny the transaction; determining, at the payment network, that the issuer is unavailable; in response to determining that the issuer is unavailable, sending the authorization request to a stand-in system on the payment network to approve or deny the transaction; determining, at the stand-in system on the payment network, to approve the transaction based in part on transaction history of the user and the user profile including the details of the user received from the instance of the application; and completing, by the payment network, authorization of the transaction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment card process.

FIG. 2 illustrates an example payment card process with an authorization stand-in system.

FIGS. 3A and 3B illustrate a conceptual diagram and method for a direct channel application for a payment network.

FIGS. 4A and 4B illustrate an example operating environment and method utilizing a direct channel application to payment network.

FIG. 5 illustrates a representation of an example payment network system supporting a direct channel application to the payment network.

FIG. 6 illustrates components of a computing system that may be used to implement certain methods and services described herein.

### DETAILED DESCRIPTION

Systems and methods for a direct channel application to a payment network to enable users to directly communicate with a payment network are described. Advantageously, as described herein, an application server at a payment network enables a direct channel for users to interact directly with the payment network. By creating a direct channel between the payment network and the user, the payment network can, among other actions, enhance the accuracy of their transaction authorization, decreasing the rate of fraudulent transactions.

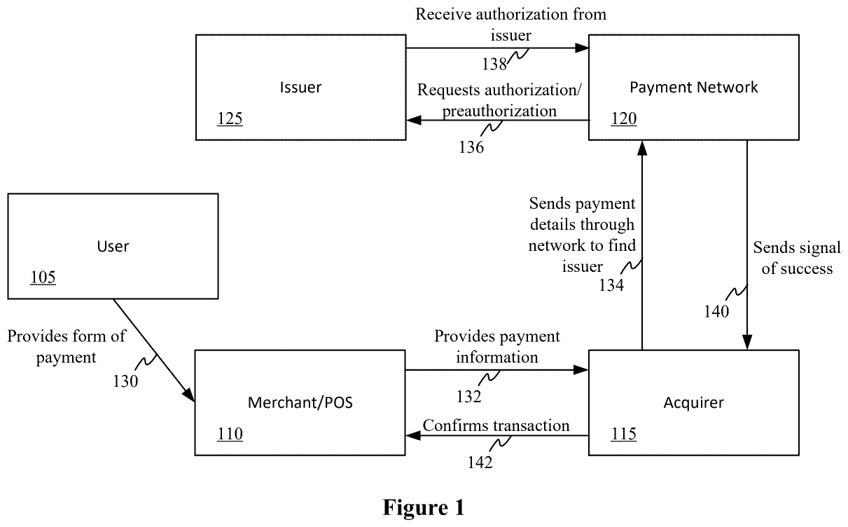

FIG. 1 illustrates an example conventional payment card process. Referring to FIG. 1, in conventional payment card processes, there can be communication between a user 105, merchant 110, an acquirer 115, a payment network 120, and an issuer 125. These communications can include a payment process using a payment card. The payment process can include payment card authorization, clearing, and settlement. The user 105 can be the cardholder or a person authorized to use the account corresponding to the cardholder. The merchant 110 can be a provider of goods or services in exchange for payment. The merchant 110 can be physically present at a sale (e.g., as a point-of-sale terminal) or remote, such as an online retailer. The acquirer 115 can be a party that receives funds on behalf of the merchant 110 in a payment card transaction. The acquirer 115 can be a bank or other institution associated with the merchant 110. The payment network 120 facilitates transactions between merchants (e.g., merchant 110) and payment card issuers (e.g., issuer 125). Examples of payment network 120 include the Mastercard payment network and the Visa payment network. An issuer 125 can be a bank or other institution at which a user has an account and which issues the payment card to the user.

A process of payment card authorization can begin with a user 105 presenting a form of payment to purchase goods or services as shown in flow (130). In some cases, the form of payment can be a physical card or a contactless card (e.g., hosted on a mobile device, and available on an e-wallet). A transaction where the payment card details are captured in person, at the time of sale, can be referred to as a card-present (CP) transaction. In CP transactions, a merchant 110 can receive the payment from a physical card or contactless card via a point-of-sale (POS) terminal to obtain information about the form of payment. In some cases, such as for online merchants, the form of payment can be made remotely, without processing a physical card. A transaction where the payment card details are captured without processing a card using a card reader is referred to as a card-not-present (CNP) transaction. CNP transactions are commonly used for online purchases when a customer buys goods on the Internet or through an e-commerce transaction.

In both CP and CNP transactions, the merchant 110 can extract information about the form of payment such as the credit card number, confirmation code, and expiration date. Information obtained by the merchant 110 can also include information about the purchase, such as location, amount, goods type, and a form of verification provided. This information may be stored in some form on merchant 110 computing devices.

A payment request, comprising at least the information about the form of payment and the information about the purchase, can be provided to an acquirer 115 associated with the merchant 110 as shown at flow (132). The acquirer 115 can, in turn, provide the payment request to the payment network 120 as shown in at flow (134).

The payment network 120 can identify an issuing bank, or issuer 125, of the user's form of payment. The transaction can be logged to aid in later processes, such as clearing and settlement. The details of the transaction can also be stored in a transaction information storage, which may be associated with the payment network 120. When the payment network 120 identifies the issuer 125, the payment network 120 can send the payment request and an authorization request, requesting authorization and/or preauthorization on the form of payment from the issuer 125, as shown at flow (136).

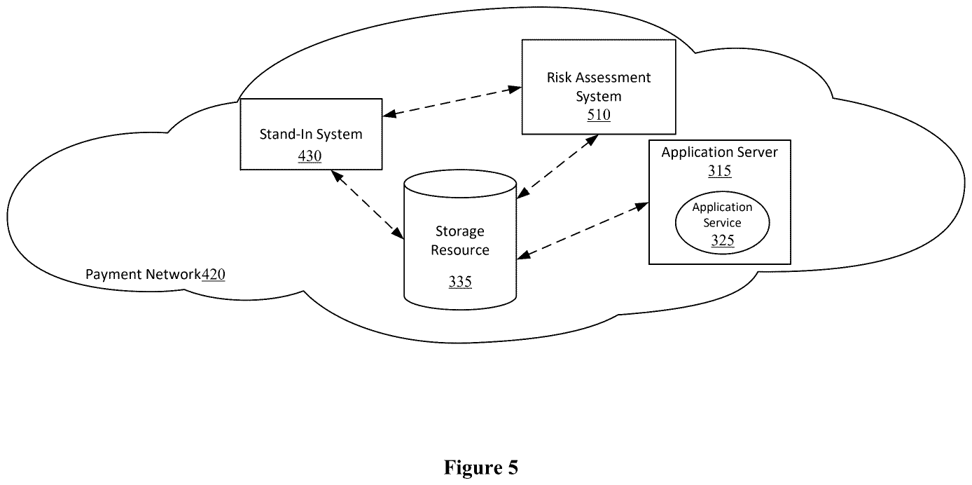

In some cases, the payment network 120 can verify the authenticity of the transaction and can provide a risk score to the issuer 125 with the authorization and/or preauthorization request. For example, the payment network 120 can calculate a risk score with respect to various aspects of the transaction, such as payment card details (e.g., historical transactions for the payment card) and merchant details, via a risk assessment system (e.g., risk assessment system 510 as described with respect to FIG. 5).

The issuer 125 can run the requested authorization or preauthorization. Authorization can entail ensuring that a transaction is legitimate, such as by checking the provided verification, location, and amount. For example, a provided form of verification can be compared against previously given verification (e.g., biometrics or signature) to determine if the user is a legitimate user for the form of payment. Similarly, an issuer 125 can compare the location against typical spending locations to detect fraudulent charges. Finally, an issuer 125 can determine that a purchase is likely to be too high value to be legitimate and flag the purchase as possibly fraudulent. The authorization can also check to see if the card is currently locked or suspended. Pre-authorization can entail determining that a user has sufficient credit or account balance to make the transaction. A credit card pre-authorization can be a temporary hold on funds equal to the payment that lasts for a period of time (e.g., 5 days). During the temporary hold, the funds cannot be used anywhere else, but the charge may not actually show up on the statement of the form of payment. After one or more of these checks are performed, the issuer 125 can accept the transaction and forward a payment result indicating success or failure back to the payment network 120 as shown at flow (138).

Once the payment result signal is received, the payment network 120 can forward the signal to the acquirer 115 as shown at flow (140). The acquirer can then forward the signal back to the merchant 110 as shown at step (142) to confirm that the transaction has been authorized. Later on, settlement and clearing can occur. In clearing, the payment and transaction information can be double checked for accuracy. In settlement, the issuer 125 can transfer funds to the payment network 120; the payment network 120 can then transfer the funds to the acquirer 115. Once the acquirer 115 receives the funds, the funds can be made available to the merchant 110.

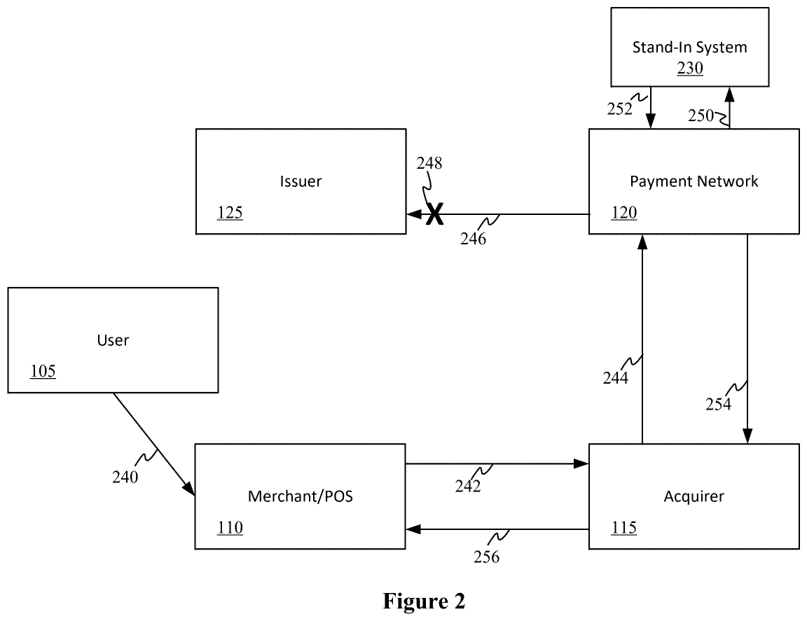

FIG. 2 illustrates an example payment card process with an authorization stand-in system. Referring to FIG. 2, processes as shown at flows (240)-(246) can be performed as described with respect to flows (130)-(136) of FIG. 1. However, unlike the conventional payment card process described with respect to FIG. 1, in the process shown in FIG. 2, the request of authorization/preauthorization to the issuer is not successful and the issuer 125 fails to send a signal indicating receipt of the request to the payment network 120 or fails to send payment result indicating success or failure back to the payment network 120, as shown in flow (248). In some cases, the failure of the communication may be due to the issuer 125 experiencing difficulties (e.g., network outages, power outage, etc.). Based on the failure of the communication between the payment network 120 and the issuer 125, it is thus determined that the issuer is unavailable and cannot perform authorization and/or preauthorization.

When an issuer is registered with a stand-in application of a stand-in system 230 on the payment network 120, if, after the payment network 120 sends the request for authorization/preauthorization, as shown in flow (246), the issuer 125 fails to respond and/or there is an indication that the issuer 125 is unavailable, the payment network 120 can then direct a request to approve or deny the transaction to the stand-in system 230 in place of the authorization/preauthorization request, as shown in (250).

The stand-in system 230 can approve or deny the transaction on behalf of an issuer (e.g., issuer 125) when the issuer is unavailable. The stand-in system 230 is a backup or temporary system that performs transaction processing when the issuer 125 is unavailable or offline. In some cases, the stand-in system 230 is a system on the payment network 120.

The stand-in system 230 can determine whether to approve or deny the transaction. Once the stand-in system 230 determines whether to approve or deny the transaction, the stand-in system 230 can accept the transaction and forward a payment result indicating success or failure back to the payment network 120 as shown in (252).

Once the payment result signal is received, the payment network 120 can forward the signal to the acquirer 115 as shown in (254). The acquirer 115 can then forward the signal back to the merchant 110 as shown in (256) to confirm that the transaction has been authorized. Later on, settlement and clearing can occur as described with respect to FIG. 1.

Conventionally, payment network stand-in systems (e.g., stand-in system 230) rely on limited pool of information available to the payment network 120. The payment network 120 (e.g., card payment processor) is not privy to extensive user information that would conventionally be available to an issuer. For example, issuers have access to user details such as name, address, current location/travel location, and email address, along with a vast catalogue of user specific transaction history.

This kind of information is not traditionally available to the payment network 120, which in many cases simply acts to facilitate the transaction between the acquirer 115 and the issuer 125. However, there are instances where the payment network 120 must act in place of the issuer 125 to approve or deny a transaction. Unfortunately, given the lack of visibility into user details and spending habits, fraudulent charges are more likely to be approved in a stand-in scenario (as opposed to when an issuer 125 determines whether to approve or deny a transaction).

Often, instead of making user specific decisions (e.g., based on user details and extensive user transaction history), the payment network 120 may instead have to rely on generic approval limits (e.g., an upper limit for a transaction amount).

Advantageously, as described herein, an application service provided by a payment network enables a direct channel for users to interact directly with the payment network. By creating a direct line between the payment network and the user, the payment network can enhance the accuracy of their transaction approval decision making, ensuring that fraudulent transactions are more successfully averted.

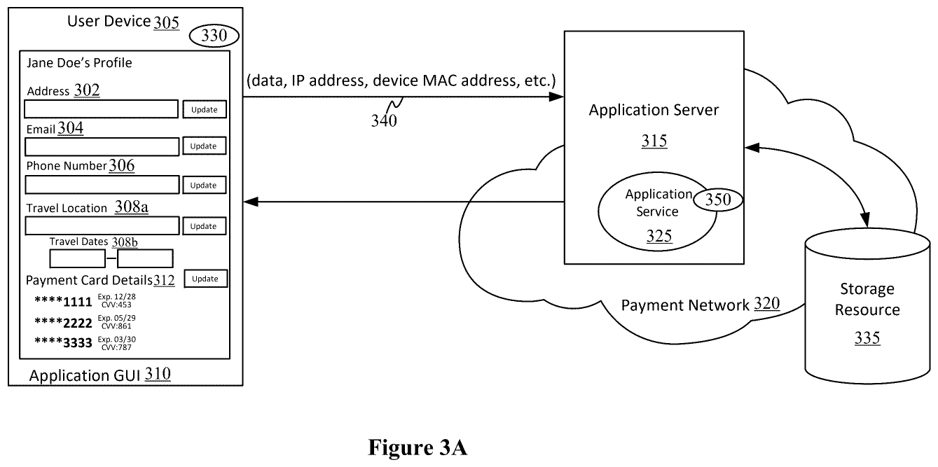

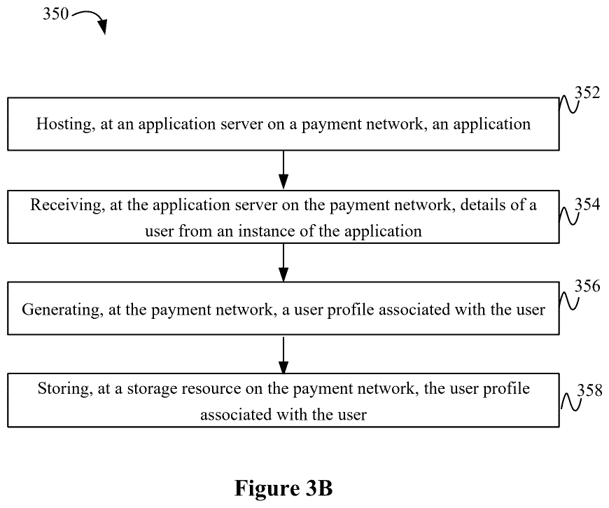

FIGS. 3A and 3B illustrate a conceptual diagram and method for a direct channel application for a payment network.

Referring to FIGS. 3A and 3B, a method 350 for a direct channel application for a payment network can include hosting (352), at an application server 315 on a payment network 320, an application (e.g., associated with application service 325); receiving (354), at the application server 315 on the payment network 320, details of a user from an instance 330 of the application; generating (356), at the payment network 320, a user profile associated with the user; and storing (358), at a storage resource on the payment network, the user profile associated with the user.

Application server 315 on the payment network 320 can host (352) an application that is accessible through a web browser or other application front end at a user device such as user device 305. The application server 315 includes an application service 325 as part of the hosted application, providing a direct channel of communication between the payment network 320 and a user. The application server 315 on the payment network 320 can execute processes enabling the application service 325.

A user device 305 can execute an application instance 330 of the application hosted by the application server 315. A user can interact with the application instance 330 on the user device 305 via an interface such as application graphical user interface (GUI) 310 at the user device 305. In some cases, the application instance 330 can be part of a wallet application.

Advantageously, the application server 315 on the payment network 320 can receive details 340 particular to the user directly from the user, for example, via application GUI 310.

The application server 315 can receive (354) details 340 of a user from the instance 330 of the application on the user device 305. For example, details 340 of the user that a user enters (e.g., via the GUI 310 at the user device 305) can include, but are not limited to, an address 302, an email address 304, a phone number 306, travel location 308a, travel dates 308b, and payment card details 312. In some cases, payment card details 312 can be provided for payment cards associated with different issuers.

In some cases, the details 340 of the user that the user device 305 can capture can include application/device state information, geolocation, and an IP address and/or a MAC address associated with the user device 305. The application instance 330 executing on the user device 305 can collect and send details 340 of the user device (e.g., IP address, MAC address, etc.) to the application server 315.

Enabling the direct channel to the payment network 320 is advantageous because the payment network 320 would otherwise not be privy to this kind of user specific information. Indeed, if a user is issued a credit card from an issuer (e.g., issuer 125 described with respect to FIGS. 1 and 2), it is the issuer who is provided with user specific details 340, even if the issued credit card is associated with a particular payment network.

In response to receiving (354) the details 340 of the user from the instance of the application on the user device 305, the payment network 320 can generate (356) a user profile associated with the user. In some cases, the application server 315 can generate (356) the user profile. In some cases, a different system on the payment network 320 can generate (356) the user profile.

The user profile can include the details 340 of the user received (354) by the application server 315 from the application instance 330 on the user device 305. In some cases, the user profile is encrypted and PCI Security Standards Council (PCI SSC) compliant.

The user profile can be stored (358) at a storage resource 335 on the payment network 320. The user profile can include details of the user provided by the user and details of the user provided by the user device 305. The details of the user stored at the user profile can include, but are not limited to, an address 302, an email address 304, a phone number 306, travel location 308a, travel dates 308b, payment card details 312, an IP address of a user device 305, and a MAC address of a user device 305.

In some cases, where a user profile has already been generated, method 350 can further include receiving, at the application server 315 on the payment network 320, new details of the user from the instance (or another instance) of the application and updating, at the payment network 320, the user profile associated with the user stored at the storage resource 335. The user can also remove details stored at the payment network 320 through an application instance (and using application service 325).

Advantageously, in certain implementations, the user data and the user profiles stored in the storage resource 335 can be used by the payment network 320 to improve authorization/preauthorization to decrease the rate of fraudulent transactions.

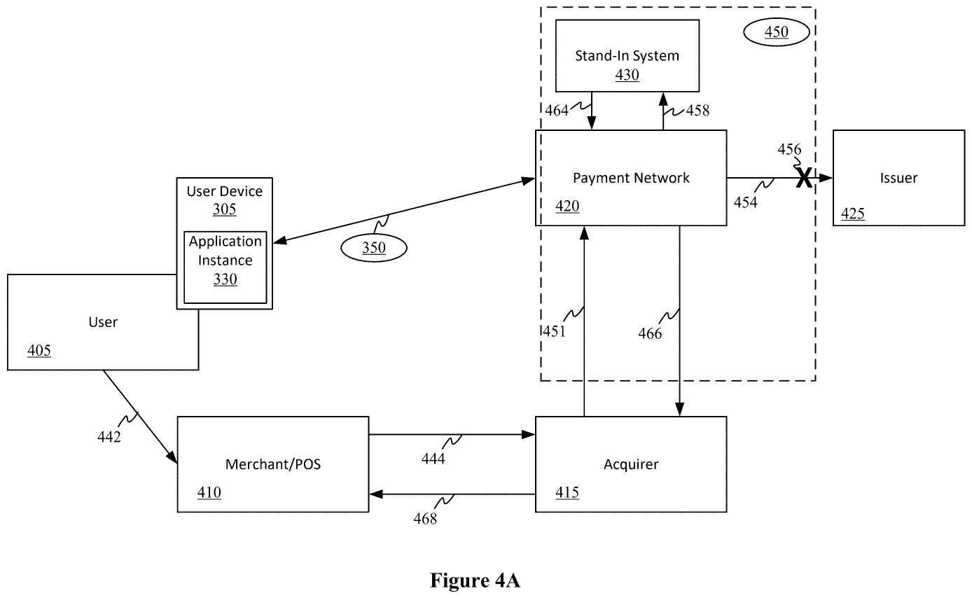

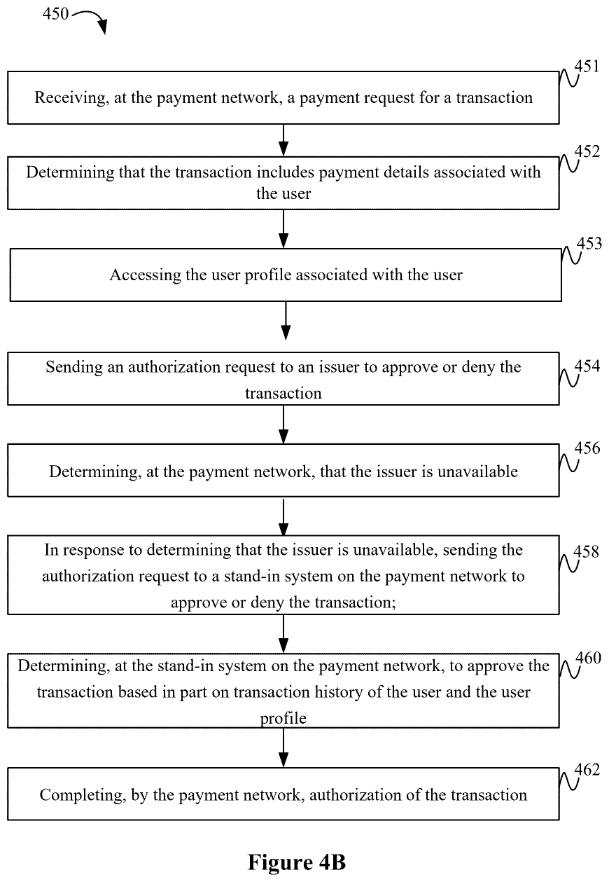

FIGS. 4A and 4B illustrate an example operating environment and method utilizing a direct channel application to payment network.

Referring to FIG. 4A, in an example scenario utilizing a direct channel application to payment network, a user 405 presents a form of payment for a transaction to purchase goods or services as shown at (442). As described with respect to FIG. 1, the form of payment can be a physical card or contactless card (e.g., CP transaction) or the form of payment can be made remotely (e.g., CNP transaction). In both CP and CNP transactions, the merchant 410 can extract information about the form of payment such as the credit card number, confirmation code, and expiration date. Information obtained by the merchant 410 can also include transaction information, such as location, amount, goods type, and a form of verification provided. In some cases, the transaction information can include an IP address associated with the transaction. This transaction information may be stored in some form on merchant computing devices.

The merchant 410 can send a payment request to an acquirer 415 associated with the merchant 410 as shown at (444). The payment request can include information about the form of payment (e.g., payment details associated with the user 405) and the transaction information.

The acquirer 415 can, in turn, provide the payment request to the payment network 420 as shown at (451).

Referring to FIG. 4B, the payment network 420 can perform method 450, including receiving (451), at the payment network 420, a payment request for a transaction; determining (452) that the transaction includes payment details associated with the user 405; accessing (453) the user profile associated with the user; sending (454) an authorization request to an issuer 425 to approve or deny the transaction; determining (456), at the payment network, that the issuer 425 is unavailable; in response to determining (456) that the issuer is unavailable; sending (458) the authorization request to a stand-in system 430 on the payment network 420 to approve or deny the transaction; determining (460), at the stand-in system 430 on the payment network, to approve the transaction based in part on transaction history of the user and the user profile comprising the details of the user received from the instance of the application; and completing (462), by the payment network 420, authorization of the transaction.

For example, referring to FIGS. 4A-4B, determining (452) that the transaction includes payment details associated with the user 405 can involve searching a data structure. The data structure may be stored at the storage resource 335 as described with respect to FIGS. 3A-3B and FIG. 5, or at a different data storage resource. In some cases, determining (452) that the transaction includes payment details associated with the user 405 can include performing a lookup operation to identify a user associated with the payment details. For example, the payment details may correspond to a particular payment card associated with the user 405 and the payment network 420 can use the information of the particular payment card to identify the user 405. It should be noted that the identification of the user 405 may be direct or indirect; however, regardless of the manner in which identification of a user is made, appropriate privacy guidelines and protections can be maintained.

Once the user 405 associated with the transaction is identified, the payment network 420 can access (453) the user profile associated with the user 405 (e.g., from the storage resource 335). In some cases, determining (452) that the transaction includes payment details associated with the user 405 and accessing (453) the user profile associated with the user 405 can occur in the same step.

As mentioned above, the payment network 420 can send (454) an authorization request to an issuer 425 to approve or deny the transaction. The authorization request may be a preauthorization request. The authorization request can include the payment details associated with the user 405 and the transaction information. In some cases, other information (e.g., a risk score as described with respect to FIG. 5) is provided as part of the authorization request sent by the payment network 420 to the issuer 425.

When sending the authorization request, the payment network 420 can determine (456) that the issuer 425 is unavailable. In some cases, the authorization request sent to the issuer 425 is unsuccessful and the issuer 425 fails to send a signal indicating receipt of the request to the payment network 420 or fails to send payment result indicating success or failure back to the payment network 420. In some cases, the failure of the communication may be due to the issuer 425 experiencing difficulties (e.g., network outages, power outage, etc.). Based on the failure of the communication between the payment network 420 and the issuer 425, the payment network 420 can determine (456) that the issuer 425 is unavailable to perform authorization and/or preauthorization.

In response to determining (456) that the issuer 425 is unavailable, the payment network 420 can send (458) the authorization request to a stand-in system 430 on the payment network 420 to approve or deny the transaction.

Method 450 can further include, when sending (458) the authorization request to the stand in system 430, sending information of the user profile to the stand-in system 430. Information of the user profile can include an access location of the storage resource (e.g., a URL) (e.g., storage resource 335), an access location of the user profile at the storage resource, details of the user stored at the user profile, and/or score data based on the user profile (e.g., risk score as described with respect to FIG. 5).

Advantageously, asynchronously with the transaction, the user 405 has provided details of the user 405 to the payment network 420 via the application instance 330 executing on the user device 305 (e.g., via method 350 described with respect to FIGS. 3A-3B). Therefore, the details of the user 405 received from the application instance 330 and stored at the storage resource (e.g., storage resource 335) can provide user specific information that can be used by the stand-in system 430 to make a more accurate, and therefore more secure, determination to approve or deny the transaction.

The stand-in system 430 can determine (460) to approve the transaction based in part on transaction history of the user and the user profile including the details of the user 405 received from the application instance 330 (e.g., via method 350 as described with respect to FIGS. 3A-3B). The details of the user may be obtained directly from the user profile stored at a storage resource (e.g., storage resource 335) or may be provided by the payment network 420 to the stand-in system 430 as needed. The transaction history of the user may be directly or indirectly accessed by the stand-in system 430. In some cases, the transaction history of the user can include transaction history of a payment card associated with the user 405 (e.g., payment card associated with the payment details associated with the user).

In some cases, the stand-in system 430 can determine to deny the transaction based in part on transaction history of the user 405 and the user profile including the details of the user received from the application instance 330.

In some cases, method 450 can include generating, at a risk assessment system (e.g., risk assessment system 510 of the payment network 420 as described with respect to FIG. 5), a risk score representing a level of fraud risk associated with a particular transaction based in part on the transaction history of the user and the user profile. The risk score may be generated before the payment network sends the authorization request to the issuer and optionally sent to the issuer as well as to the stand-in system 430 or may be generated specifically for the stand-in system 430. In some cases in which a risk score is generated, the stand-in system 430 can determine (460) to approve the transaction based in part on the risk score generated by a risk assessment system.

In some cases, determining (460) to approve the transaction can include comparing the details of the user received from the instance of the application to transaction information included in the authorization request along with certain information from the user profile.

For example, if the user profile indicates that the IP address sent from the application instance 330 was in Gainesville, Florida on Jul. 10, 2024, and the transaction information indicates that the transaction is a card-present transaction and the merchant location is in Orlando, Florida on Jul. 11, 2024, the stand-in system 430 may determine (460) to approve the transaction. Indeed, after comparing the IP address location (Florida) sent from the application instance 330 (e.g., details of the user stored in the user profile) to the merchant location (Florida) included in the transaction history, the stand-in system 430 may determine (460) to approve the transaction based on the comparison (e.g., fraud risk is low since traveling a few hours in one day is reasonable).

Alternatively, if the user profile indicates that the IP address sent from the application instance 330 was in Florida on Jul. 10, 2024, and the transaction information indicates that the transaction is a card-present transaction and the merchant location is in Switzerland on Jul. 11, 2024, the stand-in system 430 may determine to deny the transaction. In this case, after comparing the IP address location (Florida) sent from the application instance 330 (e.g., details of the user stored in the user profile) to the merchant location (Switzerland) included in the transaction history, the stand-in system 430 may determine to deny the transaction based on the comparison (e.g., fraud risk is high since traveling a few hours in one day is reasonable).

However, if the user has used the application instance 330 to update their travel location to Switzerland, the user details in the user profile at the payment network 420 would include this information, and the stand-in system 430 may determine (460) to approve the transaction based in part on the user profile.

Once the stand-in system 430 has determined (460) to approve the transaction based in part on the transaction history and the user profile including the details of the user 405 received from the application instance 330, the payment network can complete (462) authorization of the transaction. Completing (462) authorization of the transaction can include receiving a signal of approval at the payment network 420 from the stand-in system 430, as shown at (464). The payment network 420 can forward the signal of approval to the acquirer 415 as shown at (466). The acquirer 415 can then forward the approval signal back to the merchant 410 as shown at (468) to confirm that the transaction has been authorized. Later on, settlement and clearing can occur as described with respect to FIG. 1.

In some cases, when the stand-in system 430 determines to deny the transaction based in part on the transaction history and the user profile, the stand-in system 430 can send a signal of denial to the payment network 420 and the payment network 420 can forward the signal of denial to the acquirer 415.

Example Use Case. The following is an example use case including both method 350 described with respect to FIG. 3B and method 450 as described with respect to FIGS. 4A-4B.

Referring to FIGS. 3A-3B and FIGS. 4A-4B, in this example, the user 405 is travelling abroad in Greece. The user 405, via the application instance 330 on user device 305 can update their travel location and travel dates with the payment network 420.

An application server (e.g., application server 315) at payment network 420 (e.g., payment network 320) can host (352) an application. A user device 305 can execute an application instance 330 of the application hosted by the application server.

At the application instance 330, the user 405 can update their travel location 308a and travel dates 308b at the application GUI 310 at user device 305 (e.g., user device 305).

The application server 315 on the payment network 320 can receive (e.g., in operation 354) the travel location/travel dates (e.g., details of the user) from the application instance 330. The payment network 320 can generate (e.g., in operation 356) a user profile associated with the user 405 that includes the travel location/travel dates. The payment network 320 can store (e.g., in operation 358) the user profile associated with the user 405 at the storage resource (e.g., storage resource 335) on the payment network 320.

While making a purchase in Greece, the user 405 presents a particular payment card associated with the user 405 to purchase goods or services, as shown at (442). A payment request associated with the transaction can be provided to an acquirer 415 associated with merchant 410, as shown at (444). The payment request can include payment details associated with the particular payment card and transaction information associated with the purchase. For example, the transaction information associated with the purchase can include, but are not limited to, a merchant identifier, merchant location, transaction total. In this case, the transaction information can include a merchant location in Greece.

The acquirer 415 can, in turn, provide the payment request to the payment network 420 as shown at (451).

The payment network 420 receives (451) the payment request for a transaction. The payment network 420 determines (452) that the transaction includes payment details associated with user 405, and accesses (453) the user profile associated with the user. In this scenario, the payment network 420 can search a data structure using the payment details to determine that the particular payment card identified by the payment details is associated with user 405. The payment network 420 can also access the user profile associated with the user 405, which includes the travel location/travel dates indicating that the user 405 in Greece.

The payment network 420 can send (454) an authorization request to the issuer 425 to approve or deny the transaction. The payment network 420 can determine (456) that the issuer 425 is unavailable to approve or deny the transaction. In response to determining (456) that the issuer 425 is unavailable, the payment network 420 can send (454) the authorization request to a stand-in system 430 on the payment network 420 to approve or deny the transaction.

The stand-in system 430 can determine (460) to approve the transaction based in part on transaction history of the user and the user profile comprising the details of the user received from the instance of the application. In some cases, the stand-in system 430 can determine (460) to approve the transaction based in part on transaction information received with the transaction. Then, the payment network 420 can complete (462) authorization of the transaction.

Advantageously, in this scenario, via the application instance 330 on user device 305, the user 405 has provided the payment network 420 with their travel location of Greece (e.g., details of the user).

The stand-in system 430 can determine (460) to approve the transaction based in part on the user profile including the travel location of Greece (e.g., details of the user 405) and the transaction information including the merchant location in Greece.

Conventionally, the payment network 420 would not have access to user specific information (e.g., travel location/travel dates) as relied on by the described stand-in system 430. Advantageously, establishing a secure channel of communication between the user 405 and the payment network 420 (e.g., via application service 325 executing on application server 315 as described with respect to FIGS. 3A-3B) provides unique datapoints associated with the user 405 that can be used to enhance the stand-in system's 430 ability to accurately authorize a transaction.

FIG. 5 illustrates a payment network system. Referring to FIG. 5, the payment network system can include a payment network 420, an application server 315, a stand-in system 430, a storage resource 335, and a risk assessment system 510.

As described herein, the stand-in system 430 is a backup or temporary system that performs transaction processing when an issuer is unavailable (e.g., offline). In some cases, the stand-in system 430 can access information stored in the storage resource 335.

The storage resource 335 can store user profiles including details of the user received from an application instance of an application hosted by the application server 315 (e.g., application instance 330 as described with respect to FIGS. 3A-3B and FIGS. 4A-4B). The storage resource 335 can store transaction history for a plurality of users.

The stand-in system 430 can also communicate with the risk assessment system 510. In some cases, the stand-in system 430 can send transaction information of a transaction to the risk assessment system 510. The risk assessment system 510 can generate a risk score representing a level of fraud risk associated with a particular transaction. In some cases, the risk assessment system 510 can utilize artificial intelligence/decision intelligence to generate a risk score. The risk assessment system 510 can access the storage resource 335 to retrieve user details stored at user profiles in the storage resource 335. In some cases, the risk score can be a personalized risk score associated with a user based in part on the user details stored in the user profile. In some cases, the risk assessment system 510 can provide the risk score to the stand-in system 430. In some cases, the risk score can be provided to an issuer for use in authorization/preauthorization (e.g., as described with respect to FIG. 1). Advantageously, the risk score can provide confidence to the stand-in system 430 or the issuer for the authenticity the transaction.

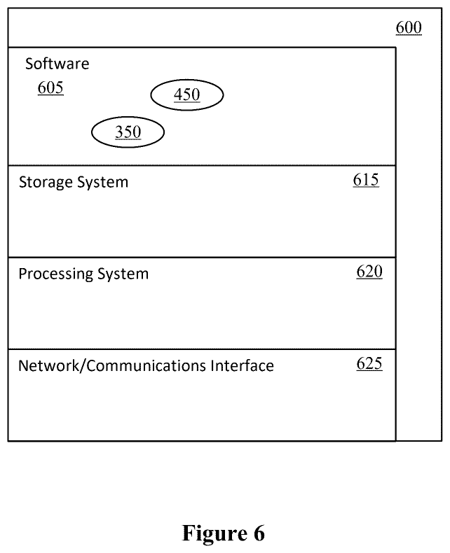

FIG. 6 illustrates components of a computing system that may be used to implement certain methods and services described herein. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices.

The system 600 can include a processing system 620, which may include one or more processors and/or other circuitry that retrieves and executes software 605 from storage system 615. Processing system 620 may be implemented within a single processing device but may also be distributed across multiple processing devices or sub-systems that cooperate in executing program instructions.

Examples of processing system 620 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof.

Storage system 615 can include any computer readable storage media readable by processing system 620 and capable of storing software 605 and data. Storage system 615 may be implemented as a single storage device but may also be implemented across multiple storage devices or sub-systems co-located or distributed relative to each other. Storage system 615 may include additional elements, such as a controller, capable of communicating with processing system 620.

Software 605 may be implemented in program instructions and among other functions may, when executed by system 600 in general or processing system 620 in particular, direct the system 600 or processing system 620 to operate as described herein for enabling a direct channel application for a payment network or for completing a transaction at a stand-in system on a payment network. For example, software 605 may provide program instructions that implement method 350 or other operations described with respect to FIG. 3B and/or method 450 or other operations described with respect to FIG. 4B.

Software 605 may also include additional processes, programs, or components, such as operating system software or other application software. Software 605 may also include firmware or some other form of machine-readable processing instructions executable by processing system 620.

A communication interface 625 may be included, providing communication connections and devices that allow for communication between system 600 and other computing systems.

Communication to and from client computing devices, beacons, and other computing systems (not shown) may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method, comprising:
hosting, at an application server on a payment network, an application;
receiving, at the application server on the payment network, details of a user from the user via an instance of the application;
generating, on the payment network, a user profile associated with the user, wherein the user profile comprises the details of the user received from the instance of the application;
storing, at a storage resource on the payment network, the user profile associated with the user;
receiving, at the payment network, a payment request for a transaction;
determining that the transaction includes payment details associated with the user;
accessing the user profile associated with the user;
sending an authorization request to an issuer to approve or deny the transaction;
determining, at the payment network, that the issuer is unavailable;
in response to determining that the issuer is unavailable, sending the authorization request to a stand-in system on the payment network to approve or deny the transaction;
determining, at the stand-in system on the payment network, to approve the transaction based in part on transaction history of the user and the user profile comprising the details of the user received from the instance of the application; and
completing, by the payment network, authorization of the transaction.

2. The method of claim 1,
receiving, at the payment network, a second payment request for a second transaction;
determining that the second transaction includes payment details associated with the user;
accessing the user profile associated with the user;
sending a second authorization request to the issuer to approve or deny the second transaction;
determining, at the payment network, that the issuer is unavailable;
in response to determining that the issuer is unavailable, sending the second authorization request to the stand-in system on the payment network to approve or deny the second transaction;
determining, at the stand-in system on the payment network, to deny the second transaction based in part on the transaction history of the user and the user profile comprising the details of the user received from the instance of the application; and
forwarding a signal of denial to an acquirer associated with the second transaction.

3. The method of claim 1, further comprising:
receiving, at the application server on the payment network, new details of the user from the instance of the application; and
updating, at the payment network, the user profile associated with the user stored at the storage resource.

4. The method of claim 1, further comprising:
generating, at a risk assessment system on the payment network, a risk score representing a level of fraud risk associated with a particular transaction based in part on the transaction history of the user and the user profile comprising the details of the user;
wherein determining, at the stand-in system on the payment network, to approve the transaction based in part on transaction history of the user and the user profile comprising the details of the user received from the instance of the application comprises determining to approve the transaction based in part on the risk score.

5. The method of claim 1, wherein the details of the user received from the instance of the application comprise an IP address.

6. The method of claim 1, wherein the details of the user received from the instance of the application comprise a travel location.

7. The method of claim 6, wherein the payment request comprises transaction information including a merchant location, wherein the authorization request comprises the transaction information, and wherein determining, at the stand-in system on the payment network, to approve the transaction based in part on the transaction history of the user and the user profile comprising the details of the user received from the instance of the application comprises comparing the travel location of the details of the user received from the instance of the application to the merchant location of the transaction information.

8. The method of claim 1, wherein, when sending the authorization request to the stand-in system, the method further comprises sending information of the user profile.

9. A system comprising:
a processing system;
one or more storage media; and
instructions stored on the one or more storage media that, when executed by the processing system, direct the processing system to at least:
host, at an application server on a payment network, an application;
receive, at the application server on the payment network, details of a user from the user via an instance of the application;
generate, on the payment network, a user profile associated with the user, wherein the user profile comprises the details of the user received from the instance of the application;
store, at a storage resource on the payment network, the user profile associated with the user;
receive, at the payment network, a payment request for a transaction;
determine that the transaction includes payment details associated with the user;
access the user profile associated with the user;
send an authorization request to an issuer to approve or deny the transaction;
determine, at the payment network, that the issuer is unavailable;
in response to determining that the issuer is unavailable, send the authorization request to a stand-in system on the payment network to approve or deny the transaction;
determine, at the stand-in system on the payment network, to approve the transaction based in part on transaction history of the user and the user profile comprising the details of the user received from the instance of the application; and
complete, by the payment network, authorization of the transaction.

10. The system of claim 9, wherein the instructions further direct the processing system to:
receive, at the payment network, a second payment request for a second transaction;
determine that the second transaction includes payment details associated with the user;
access the user profile associated with the user;
send a second authorization request to the issuer to approve or deny the second transaction;
determine, at the payment network, that the issuer is unavailable;
in response to determining that the issuer is unavailable, send the second authorization request to the stand-in system on the payment network to approve or deny the second transaction;
determine, at the stand-in system on the payment network, to deny the second transaction based in part on the transaction history of the user and the user profile comprising the details of the user received from the instance of the application; and
forward a signal of denial to an acquirer associated with the second transaction.

11. The system of claim 9, wherein the instructions further direct the processing system to:
receive, at the application server on the payment network, new details of the user from the instance of the application; and
update, at the payment network, the user profile associated with the user stored at the storage resource.

12. The system of claim 9, wherein the instructions further direct the processing system to:
generate, at a risk assessment system on the payment network, a risk score representing a level of fraud risk associated with a particular transaction based in part on the transaction history of the user and the user profile comprising the details of the user;
wherein the instructions to determine, at the stand-in system on the payment network, to approve the transaction based in part on transaction history of the user and the user profile comprising the details of the user received from the instance of the application further direct the processing system to determine to approve the transaction based in part on the risk score.

13. The system of claim 9, wherein the details of the user received from the instance of the application comprise an IP address.

14. The system of claim 9, wherein the details of the user received from the instance of the application comprise a travel location.

15. The system of claim 14, wherein the payment request comprises transaction information including a merchant location, wherein the authorization request comprises the transaction information, and wherein the instructions to determine, at the stand-in system on the payment network, to approve the transaction based in part on the transaction history of the user and the user profile comprising the details of the user received from the instance of the application further direct the processing system to compare the travel location of the details of the user received from the instance of the application to the merchant location of the transaction information.

16. The system of claim 9, wherein the instructions to send the authorization request to the stand-in system further direct the processing system to send information of the user profile to the stand-in system.

17. A computer readable storage medium having instructions of payment network system stored thereon that when executed by a computing system, direct the computing system to at least:
host, at an application server on a payment network, an application;
receive, at the application server on the payment network, details of a user from the user via an instance of the application;
generate, on the payment network, a user profile associated with the user, wherein the user profile comprises the details of the user received from the instance of the application;
store, at a storage resource on the payment network, the user profile associated with the user;
receive, at the payment network, a payment request for a transaction;
determine that the transaction includes payment details associated with the user;
access the user profile associated with the user;
send an authorization request to an issuer to approve or deny the transaction;
determine, at the payment network, that the issuer is unavailable;
in response to determining that the issuer is unavailable, send the authorization request to a stand-in system on the payment network to approve or deny the transaction;
determine, at the stand-in system on the payment network, to approve the transaction based in part on transaction history of the user and the user profile comprising the details of the user received from the instance of the application; and
complete, by the payment network, authorization of the transaction.

18. The computer readable storage medium of claim 17, wherein the instructions further direct the computing system to:
receive, at the payment network, a second payment request for a second transaction;
determine that the second transaction includes payment details associated with the user;
access the user profile associated with the user;
send a second authorization request to the issuer to approve or deny the second transaction;
determine, at the payment network, that the issuer is unavailable;
in response to determining that the issuer is unavailable, send the second authorization request to the stand-in system on the payment network to approve or deny the second transaction;
determine, at the stand-in system on the payment network, to deny the second transaction based in part on the transaction history of the user and the user profile comprising the details of the user received from the instance of the application; and
forward a signal of denial to an acquirer associated with the second transaction.

19. The computer readable storage medium of claim 18, wherein the instructions further direct the computing system to:
receive, at the application server on the payment network, new details of the user from the instance of the application; and
update, at the payment network, the user profile associated with the user stored at the storage resource.

20. The computer readable storage medium of claim 17, wherein the instructions further direct the computing system to:
generate, at a risk assessment system on the payment network, a risk score representing a level of fraud risk associated with a particular transaction based in part on the transaction history of the user and the user profile comprising the details of the user;
wherein the instructions to determine, at the stand-in system on the payment network, to approve the transaction based in part on transaction history of the user and the user profile comprising the details of the user received from the instance of the application further direct the computing system to determine to approve the transaction based in part on the risk score.
